(19) United States
(12) Patent Application Publication
(10) Pub. No.: US 2016/0073633 A1
(43) Pub. Date: Mar. 17, 2016

(54) CROP ENHANCEMENT

(71) Applicant: SYNGENTA PARTICIPATIONS AG, Basel (CH)

(72) Inventor: Ulrich Johannes HAAS, Stein (CH)

(73) Assignee: Syngenta Participations AG, Basel (CH)

(21) Appl. No.: 14/787,388

(22) PCT Filed: Apr. 25, 2014
(86) PCT No.: PCT/EP2014/058511

§ 371 Date: Oct. 27, 2015

(30) Foreign Application Priority Data
Apr. 30, 2013 (EP) 13165998.9

(51) Int. Cl. A01N 43/54

(52) U.S. Cl. CPC A01N 43/54

(57) ABSTRACT

A method for increasing the resistance of a potato plant to cold stress and/or improving plant growth which method comprises treating the potato tuber from which the plant is to grow with at least one strobilurin at surprisingly very low rates.

The present invention relates to the use of strobilurin compounds for improving the tolerance of potato plants to chilling temperatures and/or to increase plant growth (vigor, greening, shoot numbers, shoot growth length, increased fresh mass, improved plant stand etc.) of the plants. In particular, the invention further relates to the use of strobilurin at very low rates, preferably at rates below 25 g/ha to achieve these effects. In particular, the invention relates to the use of azoxystrobin at low rates below 25 g/ha against cold stress in potato plants and to improve plant growth of potato plants.

Abiotic stress is triggered in plants or their seeds for example by extreme temperatures such as heat, chill, great variations in temperature, or unseasonal temperatures, drought, extreme wetness, high salinity, radiation (for example increased UV radiation as the result of the diminishing ozone layer), increased amount of ozone in the vicinity of the soil and/or organic and inorganic pollution (for example as the result of phytotoxic amounts of pesticides or contamination with heavy metals).

Abiotic stress, such as cold, leads to a reduced quantity and/or quality of the stressed plant and its fruits. Thus, for example, the synthesis and accumulation of proteins is mainly adversely affected by temperature stress, while growth and polysaccharide synthesis are reduced by virtually all stress factors. This leads to biomass losses and to a reduced nutrient content of the plant product. Extreme temperatures, in particular cold and chill, moreover delay germination and emergence of the seedlings and reduce the plant's height and its root length.

A delayed germination and emergence often implicates a generally delayed development of the plant and for example a belated ripening. A reduced root length of the plant implies less nutrient uptake from the soil and less resistance to oncoming temperature extremes, in particular drought. The current trend for potato growers to start sowing and planting ever earlier augments the plant's and the seed's risk to be exposed to abiotic stress, in particular cold and chill.

It is therefore an object of the present invention to provide compounds which enhance a plant's or a plant's seed resistance to cold stress.

Surprisingly, it has been found that strobilurins even at very low rates have such a resistance-enhancing effect. WO07104660 discloses the use of strobilurins against chilling in plants, but not at such low rates surprisingly found to be useful for potato plants.

Accordingly, in a first aspect, the invention relates to a method for increasing the resistance of a potato plant to cold stress which method comprises treating the tubers or the surrounding growing medium with at least one strobilurin at a rate of less than 25 g/ha.

In a second aspect, it is also of interest to find compounds that enhance the growth of the plant even in the absence of abiotic stress i.e. increased vigor, greening, shoot numbers, shoot growth length, fresh mass, improved plant stand. This means a method for increasing the plant growth of a potato plant which method comprises treating the tuber or the surrounding growing medium with at least one strobilurin at a rate of less than 25 g/ha.

“Growing medium”, “growth medium” or “growth substrate” refers to any type of substrate in which the seed is sown and the plant grows or will grow, such as soil (for example in a pot, in borders or in the field) or artificial media. As a rule, it takes the form of the soil.

The use and the method according to the invention enhance the resistance of the plant against cold stress and/or causes enhanced plant growth.

The abiotic stress effect manifests itself for example in that tubers which have been exposed to a specific abiotic stress factor germinate more poorly.

Poorer germination means that the same number of tubers gives rise to fewer plants in comparison with tubers which have not been exposed to the same specific abiotic stress factor.

Alternatively, or additionally, the abiotic stress effect may manifest itself in reduced emergence.

“Emergence” is understood as meaning that the seedling appears from the soil (or, in other words, that the coleoptil or the cotyledons or the shoot or the leaf break through the soil surface).

Reduced emergence means that fewer plants appear from the soil from the same number of tubers in comparison with tubers which have not been exposed to the same specific abiotic stress factor.

Globally, abiotic stress may manifest itself in diminished vitality of the plants (=plant vigor).

Diminished vitality can be ascertained by comparison with plants whose seeds have not been exposed to the same specific abiotic stress factor.

The vitality of a plant manifests itself in a variety of factors.

Examples of factors which are manifestations of the plant's vitality are:

(a) overall visual appearance;

(b) root growth and/or root development;

(c) size of the leaf area;

(d) intensity of the leaves' green coloration;

(e) number of dead leaves in the vicinity of the ground;

(f) plant height;

(g) plant weight;

(h) growth rate;

(i) appearance and/or number of fruits;

(j) quality of the fruits;

(k) plant stand density;

(l) germination behavior;

(m) emergence behavior;

(n) shoot number;

(o) shoot type (quality and productivity)

(p) toughness of the plant, for example resistance to biotic or abiotic stress;

(q) presence of necroses;

(r) senescence behavior.

Accordingly, abiotic stress can manifest itself in a worsening of at least one of the abovementioned factors, for example in

(a) a poorer overall visual appearance;

(b) poorer root growth and/or poorer root development (see hereinabove);

(c) reduced size of the leaf area;

(d) less intense green coloration of the leaves;

(e) more dead leaves in the vicinity of the ground;

(f) lower plant height (“stunting” of the plant, see also hereinabove);

(g) lower plant weight;

(h) poorer growth rate;

(i) poorer appearance and/or lower number of fruits;

(j) diminished quality of the fruits;

(k) lower plant stand density;

(l) poorer germination behavior (see hereinabove); (m) poorer emergence behavior (see hereinabove);

(n) fewer shoots;

(o) shoots in lower quality (for example weak shoots), less productive shoots

(p) reduced toughness of the plant, for example reduced resistance to biotic or abiotic stress; (q) presence of necroses;

(r) poorer senescence behavior (earlier senescence).

The most important abiotic stress against potatoes is triggered for example by extreme temperatures such as cold, and chill.

Abiotic stress leads to a reduced quantity and/or quality of the stressed plant and its crop.

Thus, for example, the synthesis and accumulation of proteins is mainly adversely affected by temperature stress, while growth and polysaccharide synthesis are reduced by virtually all stress factors.

This leads to biomass losses and to a reduced nutrient content of the plant product.

Extreme temperatures, in particular cold and chill, moreover delay germination and emergence and reduce the plant's height and its root length.

A delayed germination and emergence often implicates a generally delayed development of the plant and for example a belated ripening.

A reduced root length of the plant implies less nutrient uptake from the soil and less resistance to oncoming temperature extremes, in particular drought.

In a preferred embodiment, the method of the invention serves for increasing the resistance of a plant or of a plant's seed to temperature extremes, in particular to cold temperatures (chill) and/or to great variations in temperature.

Accordingly, the use according to the invention preferably is for increasing the resistance of a plant or of a plant's seed to temperature extremes, in particular to cold temperatures (chill) and/or to great variations in temperature.

If temperature falls below a critical value, cold stress leading to ice formation inside the plant tissue can even cause an irreversible physiological condition that is conductive to death or malfunction of the plant's cells.

The use of strobilurins according to the invention enhances the plant's resistance to both types of negative effects of cold temperature (i.e. delayed development and dead or damaged plant tissue).

“Cold temperature” in the context of the present invention is generally understood as a temperature of at most 15° C., preferably of at most 10° C.

As a matter of course, as plants differ in their resistance to low temperature, the meaning of the term “cold temperature” also depends on the respective plant (variety) and seed from which it is to grow and on its growing stage.

The skilled person is aware of the temperature below which a certain plant at a certain growth stage is damaged or impeded in its development.

Germination is delayed for most plants if temperature is below 15° C. Germination is impeded even more below 10° C.

More preferably, the method of the invention serves for improving the vitality of a plant or of a plant's seed which is exposed to cold temperature and/or extremes in temperature (=great variations in temperature).

The method for increasing the resistance of a potato plant to cold stress according to the invention comprises
planting the potato tubers and leaving them uncovered
treating the uncovered potato tubers with at least one strobilurin
covering the potato tubers with soil
optionally applying further strobilurin over the soil
   wherein the total amount of strobilurin applied is less than 25 g/ha, preferably less than 20 g/ha, more preferably less than 15 g/ha, more preferably less than 10 g/ha, more preferably less than 7.5 g/ha, most preferably less than 5 g/ha.

However, the method of the invention also covers the embodiment wherein the tubers are treated with strobilurin before being planted.

In addition, the method of the present invention also covers the embodiment wherein only the soil surrounding and/or covering the tubers is treated with strobilurin e.g. before addition of tubers, once tubers have been planted and left uncovered and/or once the tubers have been covered.

Indeed, any combination of treatment of tubers and/or soil is encompassed by the present invention as long as the total amount of strobilurin applied in less than 25 g/ha, preferably less than 20 g/ha, more preferably less than 15 g/ha, more preferably less than 10 g/ha, more preferably less than 7.5 g/ha, most preferably less than 5 g/ha.

The strobilurin is preferably selected from pyraclostrobin, dimoxystrobin, picoxystrobin, trifloxystrobin, enestroburin, orysastrobin, metominostrobin, azoxystrobin and fluoxastrobin. More preferably, the strobilurin is selected from azoxystrobin.

In this method the strobilurin is applied preferably at a rate of less than 20 g/ha, more preferably less than 15 g/ha, more preferably less than 10 g/ha, more preferably less than 7.5 g/ha, most preferably less than 5 g/ha.

The potato tubers may also be pre-germinated before treating the tubers with strobilurin. Pre-germinated means it has a 2-3 mm long sprout.

The method of protecting the potatoes against cold stress with strobilurins also results in earlier germination and/or increased emergence and/or increased plant height and/or increased root length and/or increased chlorophyll content and/or improved plant vitality and/or increased shoot number and/or increased shoot fresh mass.

In another preferred embodiment, the method of the invention serves for improving the vitality of a potato plant even if it is NOT exposed to abiotic stress, by applying the strobilurin at a rate of less than 25 g/ha to the potato tubers.

Accordingly, in an embodiment, the invention relates to a method for improving plant growth of potato plants.

Accordingly, improved plant growth can manifest itself in an improvement in at least one of the below, for example:

(a) a better overall visual appearance;

(b) increased root growth and/or root development;

(c) increased size of the leaf area;

(d) more intense green coloration of the leaves (increased chlorophyll content);

(e) less dead leaves in the vicinity of the ground;

(f) higher plant height;

(g) increased plant weight (e.g. increased shoot fresh mass);

(h) faster growth rate;

(i) increased plant stand density;

(j) increased germination;

(m) increased emergence;

(k) more shoots;

(l) shoots in higher quality (for example weak shoots)

(p) increased toughness of the plant

(r) increased senescence behavior (e.g. earlier senescence).

In another more preferred embodiment, the invention relates to the use of at least one strobilurin for improving the germination of plants.

Improved germination means that the same number of tubers gives rise to more plants in comparison with tubers which have not been treated with the at least one strobilurin.

In another preferred embodiment, the improved plant vigor—additionally or alternatively—manifests itself in an improved emergence.

Accordingly, in a more preferred embodiment, the invention relates to a method for improving the emergence of plants at very low rates i.e. less than 25 g/ha.

In another preferred embodiment, the improved plant vigor/growth—additionally or alternatively—manifests itself in a reduced stunting, or, in other words, in an increased plant height of the potato plants.

Accordingly, in a more preferred embodiment, the invention relates to a method for increasing the plant height of the plants.

Reduced stunting or increased plant height means that the hypocotyl, i.e. the stalk, is at the same point of time higher than the stalk of plants which or the seeds of which have been exposed to the same abiotic stress factor(s), but which have not been treated with the at least one strobilurin.

In another preferred embodiment, the improved plant vigor/growth—additionally or alternatively—manifests itself in an increased root length of the potato plants.

Accordingly, in a more preferred embodiment, the invention relates to a method for increasing the root length of potato plants.

Increased root length means that the root is at the same point of time longer than the root of plants, which have not been treated with the at least one strobilurin.

In another preferred embodiment, the improved plant vigor/plant growth—additionally or alternatively—manifests itself in an increased shoot number of the potato plants.

Accordingly, in a more preferred embodiment, the invention relates to a method for increasing the number of shoots of the plants.

Reduced stunting or increased shoot numbers is at the same point of time higher than the shoot numbers of plants, which have not been treated with the at least one strobilurin.

In another preferred embodiment, the improved plant vigor/plant growth—additionally or alternatively—manifests itself in an increased shoot length of the potato plants.

Accordingly, in a more preferred embodiment, the invention relates to a method for increasing the shoot lengths of the plants.

Increased shoot length is at the same point of time higher than the shoot lengths of plants, which have not been treated with the at least one strobilurin.

In another preferred embodiment, the improved plant vigor/plant growth—additionally or alternatively—manifests itself in an increased shoot fresh mass of the potato plants.

Accordingly, in a more preferred embodiment, the invention relates to a method for increasing the shoot fresh mass of the plants.

Reduced stunting or increased shoot fresh mass is at the same point of time higher than the shoot fresh mass of potato plants, which have not been treated with the at least one strobilurin.

In another preferred embodiment, the improved plant vigor/plant growth—additionally or alternatively—manifests itself in an increased chlorophyll content of the potato plants.

Accordingly, in a more preferred embodiment, the invention relates to a method for increasing the chlorophyll content of the plants.

Reduced stunting or increased shoot fresh mass is at the same point of time higher than the chlorophyll of potato plants, which have not been treated with the at least one strobilurin.

In particular, the invention relates to a method for improving the plant vigor/growth of potato plants wherein the application of strobilurin, preferably azoxystrobin, to the potato tubers results in earlier germination and/or increased emergence and/or increased plant height and/or increased root length and/or increased chlorophyll content and/or improved plant vitality and/or increased shoot number and/or increased shoot length and/or increased shoot fresh mass. This is applicable both under cold stress and without any cold stress and/or any other abiotic stresses.

The method according to the invention to increase plant growth includes the embodiments wherein strobilurin is selected from pyraclostrobin, dimoxystrobin, picoxystrobin, trifloxystrobin, enestroburin, orysastrobin, metominostrobin, azoxystrobin and fluoxastrobin. Preferably, the strobilurin is selected from azoxystrobin.

The strobilurin is preferably applied at a rate of less than 25 g/ha, preferably less than 20 g/ha, more preferably less than 15 g/ha, most preferably less than 10 g/ha, more preferably less than 7.5 g/ha, most preferably less than 5 g/ha.

In one embodiment the potato tuber is pre-germinated before treating it with strobilurin. Pre-germinated means it has a 2-3 mm long sprout.

The method results in a potato plant with an earlier germination and/or increased emergence and/or increased plant height and/or increased root length and/or increased chlorophyll content and/or improved plant vitality and/or increased shoot number and/or increased shoot length and/or increased shoot fresh mass.

The method for increasing the plant growth of a potato plant according to the invention comprises
providing a strobilurin
planting the potato tubers and leaving them uncovered
treating the uncovered potato tubers with at least one strobilurin
covering the potato tubers with soil
optionally applying further strobilurin over the soil
   wherein the total amount of strobilurin applied is less than 25 g/ha, preferably less than 20 g/ha, more preferably less than 15 g/ha, and more preferably less than 10 g/ha and most preferably less than 7.5 g/ha.

However, the potato tubers can also be treated before being put into the soil.

In addition, the method of the present invention also covers the embodiment wherein only the soil surrounding and/or covering the tubers is treated with strobilurin e.g. before addition of tubers, once tubers have been planted and left uncovered and/or once the tubers have been covered.

Indeed, any combination of treatment of tubers and/or soil is encompassed by the present invention as long as the total amount of strobilurin applied in less than 25 g/ha, preferably less than 20 g/ha, more preferably less than 15 g/ha, more preferably less than 10 g/ha, more preferably less than 7.5 g/ha, most preferably less than 5 g/ha.

In all embodiments of the invention, azoxystrobin is the preferred strobilurin.

In all embodiments of the invention, the potato plants can be non-transgenic or transgenic in nature.

In one embodiment of the invention, if the plant is transgenic, it is preferred that the recombinant modification of the transgenic plant is such in nature that the plant has resistance to a certain pesticide.

It is to be understood, however, that when the plant is a transgenic plant, the transgenic events that are present in the plant are by no means limited to those that provide pesticide resistance, but can include any transgenic event. In fact, the use of “stacked” transgenic events in a plant is also contemplated.

The treatment of the potato tubers can be accomplished for example in such a way that the tuber is treated with one strobilurin, preferably azoxystrobin, or with at least two different strobilurins.

If more than one strobilurin is used the different compounds can be applied as a mixture.

Alternatively, the seed can be treated with the at least two strobilurins in separate form, it being possible for the treatment with the individual active substances to be accomplished simultaneously or in succession.

In the case of successive treatment, the time interval may be from a few seconds up to several months, for example up to 6, 8 or even 10 months.

However, the time interval must be such that the desired effect can take place.

Preferably, the interval between the treatments is relatively short, i.e. the different strobilurins are applied within a time interval of from a few seconds up to at most one month, especially preferably up to not more than one week and in particular up to not more than one day.

The tuber may be treated according to the invention before sowing, during sowing or after sowing or else via the growth substrate into which it is sown, for example during sowing in the form of what is known as the in-furrow application. In this form of application, the plant protectant is placed into the furrow essentially at the same time as the tuber.

The tubers can also be treated some time after sowing, whilst the tubers are still uncovered. Once the tubers are treated and covered with soil, the coversoil can be treated with strobilurin again.

The potato tuber can also be treated before sowing. In principle, all customary methods of treating and in particular dressing such as coating (e.g. pelleting) and imbibing (e.g. soaking) can be employed.

Specifically, the tuber treatment follows a procedure in which the tuber is exposed to the specifically desired amount of a preparation comprising the active compounds used according to the invention (=at least one strobilurin).

In the most preferred embodiment of the invention, the tubers and/or the surrounding soil are treated with a strobilurin or strobilurins at a rate of less than 25 g/ha before planting, at the time of planting or immediately after covering the tuber with soil.

Whilst the low rate treatment of the potato tubers and/or surrounding growth medium may be carried out in the presence of fungal pests, it is preferable that it is carried out in the absence of fungal pest pressure.

It is noted the strobilurins for use in the low rate application of the invention may also be used as fungicides at a further point during the growth of the potato plant at a typical rate for fungicidal effectiveness which may be determined by reference to the literature provided with commercially available strobilurins. Thus, the present invention also encompasses the use of a fungicidally effective amount of a strobilurin after treatment of the tuber and/or surrounding soil with the low rate of strobilurin of the invention. By ‘after treatment’ is meant at least one day, at least two days, at least three days, at least four days, at least five days, at least six days, at least one week, at least two weeks, at least three weeks, at least one month, at least two months or at least three months.

The strobilurin is generally formulated before being applied to the potato tubers. The possible formulations include, but are not limited to, emulsifiable concentrates, suspension concentrates, directly sprayable or dilutable solutions, spreadable pastes, dilute emulsions, soluble powders, dispersible powders, wettable powders, dusts, granules or encapsulations in polymeric substances, which comprise—at least—one of the active ingredients according to the invention and which are to be selected to suit the intended aims and the prevailing circumstances.

In these compositions, the active ingredient is employed in pure form, a solid active ingredient for example in a specific particle size, or, preferably, together with—at least—one of the auxiliaries conventionally used in the art of formulation, such as extenders, for example solvents or solid carriers, or such as surface-active compounds (surfactants).

Examples of suitable solvents are: unhydrogenated or partially hydrogenated aromatic hydrocarbons, preferably the fractions C8 to C12 of alkylbenzenes, such as xylene mixtures, alkylated naphthalenes or tetrahydronaphthalene, aliphatic or cycloaliphatic hydrocarbons, such as paraffins or cyclohexane, alcohols such as ethanol, propanol or butanol, glycols and their ethers and esters such as propylene glycol, dipropylene glycol ether, ethylene glycol or ethylene glycol monomethyl ether or ethylene glycol monoethyl ether, ketones, such as cyclohexanone, isophorone or diacetone alcohol, strongly polar solvents, such as N-methylpyrrolid-2-one, dimethyl sulfoxide or N,N-dimethylformamide, water, unepoxidized or epoxidized vegetable oils, such as unexpodized or epoxidized rapeseed, castor, coconut or soya oil, and silicone oils.

Solid carriers which are used for example for dusts and dispersible powders are, as a rule, ground natural minerals such as calcite, talc, kaolin, montmorillonite or attapulgite. To improve the physical properties, it is also possible to add highly disperse silicas or highly disperse absorbtive polymers. Suitable particulate adsorptive carriers for granules are porous types, such as pumice, brick grit, sepiolite or bentonite, and suitable non-sorptive carrier materials are calcite or sand. In addition, a large number of granulated materials of inorganic or organic nature can be used, in particular dolomite or comminuted plant residues.

Suitable surface-active compounds are, depending on the type of the active ingredient to be formulated, non-ionic, cationic and/or anionic surfactants or surfactant mixtures which have good emulsifying, dispersing and wetting properties. The surfactants mentioned below are only to be considered as examples; a large number of further surfactants which are conventionally used in the art of formulation and suitable according to the invention are described in the relevant literature.

Suitable non-ionic surfactants are, especially, polyglycol ether derivatives of aliphatic or cycloaliphatic alcohols, of saturated or unsaturated fatty acids or of alkyl phenols which may contain approximately 3 to approximately 30 glycol ether groups and approximately 8 to approximately 20 carbon atoms in the (cyclo)aliphatic hydrocarbon radical or approximately 6 to approximately 18 carbon atoms in the alkyl moiety of the alkyl phenols. Also suitable are water-soluble polyethylene oxide adducts with polypropylene glycol, ethylenediaminopo-lypropylene glycol or alkyl polypropylene glycol having 1 to approximately 10 carbon atoms in the alkyl chain and approximately 20 to approximately 250 ethylene glycol ether groups and approximately 10 to approximately 100 propylene glycol ether groups. Normally, the abovementioned compounds contain 1 to approximately 5 ethylene glycol units per propylene glycol unit. Examples which may be mentioned are nonylphenoxypolyethoxyethanol, castor oil polyglycol ether, polypropylene glycol/polyethylene oxide adducts, tributylphenoxypolyethoxyethanol, polyethylene glycol or octylphenoxypolyethoxyethanol. Also suitable are fatty acid esters of polyoxyethylene sorbitan, such as polyoxyethylene sorbitan trioleate.

The cationic surfactants are, especially, quarternary ammonium salts which generally have at least one alkyl radical of approximately 8 to approximately 22 C atoms as substituents and as further substituents (unhalogenated or halogenated) lower alkyl or hydroxyalkyl or benzyl radicals. The salts are preferably in the form of halides, methylsulfates or ethylsulfates. Examples are stearyltrimethylammonium chloride and benzylbis(2-chloroethyl)ethyl ammonium bromide.

Examples of suitable anionic surfactants are water-soluble soaps or water-soluble synthetic surface-active compounds. Examples of suitable soaps are the alkali, alkaline earth or (unsubstituted or substituted) ammonium salts of fatty acids having approximately 10 to approximately 22 C atoms, such as the sodium or potassium salts of oleic or stearic acid, or of natural fatty acid mixtures which are obtainable for example from coconut or tall oil; mention must also be made of the fatty acid methyl taurates. However, synthetic surfactants are used more frequently, in particular fatty sulfonates, fatty sulfates, sulfonated benzimidazole derivatives or alkylaryl sulfonates. As a rule, the fatty sulfonates and fatty sulfates are present as alkali, alkaline earth or (substituted or unsubstituted) ammonium salts and they generally have an alkyl radical of approximately 8 to approximately 22 C atoms, alkyl also to be understood as including the alkyl moiety of acyl radicals; examples which may be mentioned are the sodium or calcium salts of lignosulfonic acid, of the dodecylsulfuric ester or of a fatty alcohol sulfate mixture prepared from natural fatty acids. This group also includes the salts of the sulfuric esters and sulfonic acids of fatty alcohol/ethylene oxide adducts. The sulfonated benzimidazole derivatives preferably contain 2 sulfonyl groups and a fatty acid radical of approximately 8 to approximately 22 C atoms. Examples of alkylarylsulfonates are the sodium, calcium or triethanolammonium salts of decylbenzenesulfonic acid, of dibutylnaphthalenesulfonic acid or of a naphthalenesulfonic acid/formaldehyde condensate. Also possible are, furthermore, suitable phosphates, such as salts of the phosphoric ester of a p-nonylphenol/(4-14)ethylene oxide adduct, or phospholipids.

As a rule, the composition of strobilurin comprise 0.1 to 99%, especially 0.1 to 95%, of active ingredient and 1 to 99.9%, especially 5 to 99.9%, of at least one solid or liquid adjuvant, it being possible as a rule for 0 to 25%, especially 0.1 to 20%, of the composition to be surfactants (% in each case meaning percent by weight). Whereas concentrated compositions tend to be preferred for commercial goods, the end consumer as a rule uses dilute compositions which have substantially lower concentrations of active ingredient. Preferred compositions are composed in particular as follows (%=percent by weight):

Emulsifiable Concentrates:

active ingredient: 1 to 95%, preferably 5 to 20%

surfactant: 1 to 30%, preferably 10 to 20%

solvent: 5 to 98%, preferably 70 to 85%

Dusts:

active ingredient: 0.1 to 10%, preferably 0.1 to 1%

solid carrier: 99.9 to 90%, preferably 99.9 to 99%

Suspension Concentrates:

active ingredient: 5 to 75%, preferably 10 to 50%

water: 94 to 24%, preferably 88 to 30%

surfactant: 1 to 40%, preferably 2 to 30%

Wettable Powders:

active ingredient: 0.5 to 90%, preferably 1 to 80%

surfactant: 0.5 to 20%, preferably 1 to 15%

solid carrier: 5 to 99%, preferably 15 to 98%

Granulates:

active ingredient: 0.5 to 30%, preferably 3 to 15%

solid carrier: 99.5 to 70%, preferably 97 to 85%

The composition of strobilurin can also comprise further solid or liquid auxiliaries, such as stabilizers, for example unepoxidized or epoxidized vegetable oils (for example epoxidized coconut oil, rapeseed oil or soya oil), antifoams, for example silicone oil, preservatives, viscosity regulators, binders and/or tackifiers, fertilizers or other active ingredients for achieving specific effects, for example bactericides, fungicides, nematocides, plant activators, molluscicides or herbicides.

The composition of strobilurin according to the invention are prepared in a manner known per se, in the absence of auxiliaries for example by grinding, screening and/or compressing a solid active ingredient and in the presence of at least one auxiliary for example by intimately mixing and/or grinding the active ingredient with the auxiliary (auxiliaries). These processes for the preparation of the compositions and the use of the compounds I for the preparation of these compositions are also a subject of the invention.

The application methods for the composition of strobilurin, that is the methods of controlling pests of the abovementioned type, such as spraying, atomizing, dusting, brushing on, dressing, scattering or pouring—which are to be selected to suit the intended aims of the prevailing circumstance.

The compositions according to the invention may also be present together with other active compounds, for example with herbicides, insecticides, growth regulators, fungicides or else with fertilizers. When the compounds used according to the present invention, in particular the compounds (I), or the compositions comprising them, are combined with one or more further active compounds, in particular fungicides, it is in many cases possible, for example, to broaden the activity spectrum or to prevent the development of resistance. In many cases, synergistic effects are obtained.

The following lists of fungicides, insecticides, growth retardants and primers which can be used together with the strobilurin, is meant to illustrate, but not to limit, possible combinations: methyl(2-chloro-5-[1-(3-methylbenzyloxyimino)ethyl]benzyl)carbamate, methyl(2-chloro-5-[1-(6-methylpyridin-2-ylmethoxyimino)ethyl]benzyl)carbamate, methyl 2-(ortho-((2,5-dimethylphenyloxymethylene)phenyl)-3-methoxyacrylate, 2-(2-(6-3-chloro-2-methyl-phenoxy)-5-fluoro-pyrimidin-4-yloxy)-phenyl)-2-methoxyimino-N-methyl-acetamide; 3-Methoxy-2-(2-(N-(4-methoxy-phenyl)-cyclopropane-carboximidoylsulfanylmethyl)-phenyl)-acrylic acid methyl ester; Carboxamides-carboxanilides: benalaxyl, benalaxyl-M, benodanil, bixafen, boscalid, carboxin, mepronil, fenfuram, fenhexamid, flutolanil, furametpyr, metalaxyl, ofurace, oxadixyl, oxycarboxin, penthiopyrad, thifluzamide, tiadinil, 2-amino-4-methyl-thiazole-5-carboxylic acid anilide, 2-chloro-N-(1,1,3-trimethyl-indan-4-yl)-nicotinamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluoro-biphenyl-2-yl)-3-difluoromethyl-1-methylpyrazole-4-carboxamide, N′-(3′,4′- dichloro-d-fluorobiphenyl-ylJ-S-difluoromethyl-i-methylpyrazole-carboxamide, N-(2-cyanophenyl)-3,4-dichloroisothiazole-5-carboxamide, N-(2-(1,3-dimethyl-butyl)-phenyl)-1,3,3-trimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-yl-phenyl)-3-difluoromethyl-1-methyl-1H-pyrazole-4-carboxylic acid amide, N-(trans-2-bicyclopropyl-2-yl-phenyl)-3-difluoromethyl-1-methyl-1H-pyrazole-4-carboxylic acid amide; carboxylic acid morpholides: dimethomorph, flumorph; benzamides: flumetover, fluopicolide(picobenzamid), fluopyram, zoxamide, N-(3-Ethyl-3,5-5tpmethyl-cyclohexyl)-3-fopnylamino-2-hydroxy-benzamide; other carboxamides: carpropamid, diclocymet, mandipropamid, oxytetracyclin, silthiofam, N-(6-methoxy-pyridin-3-yl)cyclopropanecarboxylic acid amide, N-(2-(4-[3-(4-chlorophenyl)prop-2-ynyloxy]-3-methoxyphenyl)ethyl)-2-methanesulfo-nylamino-3-methylbutytamide, N-(2-(4-[3-(4-chlorophenyl)prop-2-ynyloxy]-3-methoxyphenyl)-ethyl)-2-ethanesulfonylamino-3-methylbutyramide; Azoles triazoles: azaconazole, bitertanol, bromuconazole, cyproconazole, difenoconazole, diniconazole, diniconazole-M, enilconazole, epoxiconazole, fenbuconazole, flusilazole, fluquinconazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimenol, triadimefon, triticonazole, uniconazole, 1-(4-chloro-phenyl)-2-([1,2,4]triazol-1-yl)-cycloheptanole; imidazoles: cyazofamid, imazalil, imazalil-sulfphat, pefurazoate, prochloraz, triflumizole; benzimidazoles: benomyl, carbendazim, fuberidazole, thiabendazole; others: ethaboxam, etridiazole, hymexazole; Nitrogenous heterocyclyl compounds pyridines: fluazinam, pyrifenox, 3-[5-(4-chlorophenyl)-2,3-dimethylisoxazolidin-3-yl]pyridine, 2,3,5,6-tetrachloro-4-methanesulfonyl-pyridine, 3,4,5-trichloro-pyridine-2,6-dicarbonitrile, N-(1-(5-Bromo-3-chloro-pyridin-2-yl)-ethyl)-2,4-dichloro-nicotinamide, N-((5-bromo-3-chloro-pyridin-2-yl)-methyl)-2,4-dichloro-nicotinamide; pyrimidines: bupirimate, cyprodinil, diflumetorim, ferimzone, fenarimol, mepanipyrim, nitrapyrin, nuarimol, pyrimethanil; piperazines: triforine; pyrroles: fludioxonil, fenpiclonil; -morpholines: aldimorph, dodemorph, dodemorph-acetate, fenpropimorph, tridemorph; dicarboximides: iprodione, fluoroimid, procymidone, vinclozolin; others: acibenzolar-S-methyl, anilazine, blasticidin-S, captan, chinomethionat, captafol, dazomet, debacarb, diclomezine, difenzoquat, difenzoquat-methylsulphat, fenoxanil, folpet, oxolinic acid, piperalin, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N₁N-dimethyl-3-(3-bromo-6-fluoro-2-methylindole-1-sulfonyl)-[1,2,4]triazole-1-sulfonamide; Carbamates and dithiocarbamates dithiocarbamates: ferbam, mancozeb, maneb, metiram, metam, methasulphocarb, propineb, thiram, zineb, ziram; carbamates: diethofencarb, benthiavalicarb, flubenthiavalicarb, iprovalicarb, propamocarb, propamocarb hydrochloric!, methyl3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

Other fungicides guanidines: dodine, dodine free base, guazatine, guazatine-acetate, iminoctadine, iminoctadine-triacetate, iminoctadine-tris(albesilate); antibiotics: kasugamycin, kasugamycin-hydrochlorid-hydrat, polyoxins, strepto mycin, validamycin A; organometal compounds: fentin salts (e.g. fentin acetate, fentin chloride, fentin hydroxide); sulfur-containing heterocyclyl compounds: isoprothiolane, dithianon; organophosphorus compounds: edifenphos, fosetyl, fosetyl-aluminum, iprobenfos, pyrazophos, tolclofos-methyl, phosphorous acid and its salts; organochlorine compounds: thiophanate methyl, chlorothalonil, dichlofluanid, dichlorophene, flusulfamide, phthalide, hexachlorobenzene, pencycuron, pentachlorophenol and salts thereof, quintozene, tolylfluanid, N-(4-chloro-2-nitro-phenyl)-N-ethyl-4-methyl-benzenesulfonamide; -nitrophenyl derivatives: binapacryl, dicloran, dinocap, dinobuton, nitrothal-isopropyl, tecnazen; inorganic active compounds: Bordeaux mixture, copper salts (e.g. copper acetate, copper hydroxide, copper oxychloride, basic copper sulfate), sulfur; others: biphenyl, bronopol, cyflufenamid, cymoxanil, diphenylamine, metrafenone, mildiomycine, oxine-copper, prohexadione-calcium, spiroxamine, tolylfluanid, N-(cyclopropylmethoxyimino-(6-difluoromethoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5- trifluormethyl-4-(3-trimethylsilanyl-propoxy)-phenyl)-N-ethyl-N-methyl formamidine, N′-(5-difluormethyl-2-methyl-4-(3-trimethylsilanyl-propoxy)-phenyl)-N-ethyl-N-methyl formamidine;

Plant growth regulators (PGRs): 3,6-dichloropicolinic acid, 1-(4-chlorophenyl)-4,6-dimethyl-2-oxo-1,2-dihydropyridine-3-carboxylic acid, methyl-3,6-dichloroanisate, abscisic acid, asulam, benzoylpropethyl, carbetamide, daminozide, difenzoquat, dikegulac, ethephon, fenpentezol, fluoridamid, glyphosate, glyphosine, hydroxybenzonitriles (e.g. bromoxynil), inabenfide, isopyrimol, long chain fatty alcohols and acids, maleic hydrazide, mefluidide, morphactins (e.g. chlorfluoroecol), paclobutrazol, phenoxyacetic acids (e.g. 2,4-D or MCPA), substituted benzoic acid (e.g. triiodobenzoic acid), substituted quaternary ammonium and phosphonium compounds (e.g. chloromequat, chlorphonium or mepiquatchloride), tecnazene, the auxins (e.g. indoleacetic acid, indolebutyric acid, naphthylacetic acid or naphthoxyacetic acid), the cytokinins (e.g. benzimidazole, benzyladenine, benzylaminopurine, diphenylurea or kinetin), the gibberellins (e.g. GA3, GA4 or GA7) and triapenthenol, prohexadione and its salts, trinexapac-ethyl, diflufenzopyr.

Primers: benzothiadiazole (BTH), salicylic acid and its derivates, beta-aminobutyric acid (BABA), 1-methylcyclopropene (1-MCP), lipopolysaccharides (LPS), neonicotinoides (e.g. acetamiprid, clothianidin, dinetofuran, fipronil, imidacloprid, thiacloprid, thiamethoxam).

Ethylene modulators: ethylene biosynthesis inhibitors, which inhibit the conversion of S-adenosyl-L-methionine into 1-aminocyclopropane-1-carboxylic acid (ACC), such as derivatives of vinylglycine, hydroxylamines, oxime ether derivatives; ethylene biosynthesis inhibitors which block the conversion of ACC into ethylene, selected from the group consisting of: Co++ or Ni++ ions in plant-available forms; phenolic radical scavengers such as n-propyl gallate; polyamines, such as putrescine, spermine or spermidine; structural analogs of ACC, such as a-aminoisobutyric acid or L-aminocyclopropene-1-carboxylic acid; salicylic acid or acibenzolar-S-methyl; structural analogs of ascorbic acid which act as inhibitors of ACC oxidase, such as prohexadione-Ca or trinexapac-ethyl; and triazolyl compounds such as paclobutrazol or uniconazole as inhibitors of cytochrome P-450-dependent monooxygenases, whose main action is to block the biosynthesis of gibberellins; inhibitors of the action of ethylene selected from the group consisting of: structural analogs of ethylene such as 1-methylcyclopropene or 2,5-norbornadiene and 3-amino-1,2,4-triazole or Ag++ ions

The active compounds mentioned above are generally known and commercially available.

As the strobilurins have a fungicidal action, they do not only enhance a plant's resistance to abiotic stress and/or improve plant growth, but also have a preventive effect on fungal attack.

They are particularly suitable for controlling the following phytopathogenic fungi:

Alternaria species,

Aphanomyces species,

Fusarium and Verticillium species

Phytophthora infestans,

Phytophthora species,

Pseudoperonospora species

Puccinia species

Pythium spp.

Rhizoctonia species

The present invention also provides a tuber that has been treated by the method described above.

It also provides a tuber obtainable by the method described above.

Still further, the present invention relates to a tuber, especially an unsown one, which comprises the above-defined active ingredients.

The examples that follow are intended to illustrate the invention, but without imposing any limitation.

For the avoidance of doubt, where a literary reference, patent application, or patent, is cited within the text of this application, the entire text of said citation is herein incorporated by reference.

### EXAMPLE 1

1.1 Experiment

A commercially available SC100 formulation of azoxystrobin was sprayed directly to uncovered potato tubers, which were sitting on soil (50% drench soil mixed with 50% sand), at two different rates:
7.5 g/ha
3.8 g/ha

The spray volume was 200 l/ha.

The check had no treatment of azoxystrobin.

The trials were repeated in 6 troughs with 3 tubers each.

Varieties tested were Allians, Belana, Marabel and Roberta. Each were tested as pre-germinated (i.e. treatment was applied when the potato tuber had 2-3 mm long sprouts) tubers and as non germinated tubers.

The temperature was about 17° C. during the day and about 15° C. during the night.

No pest pressure present.

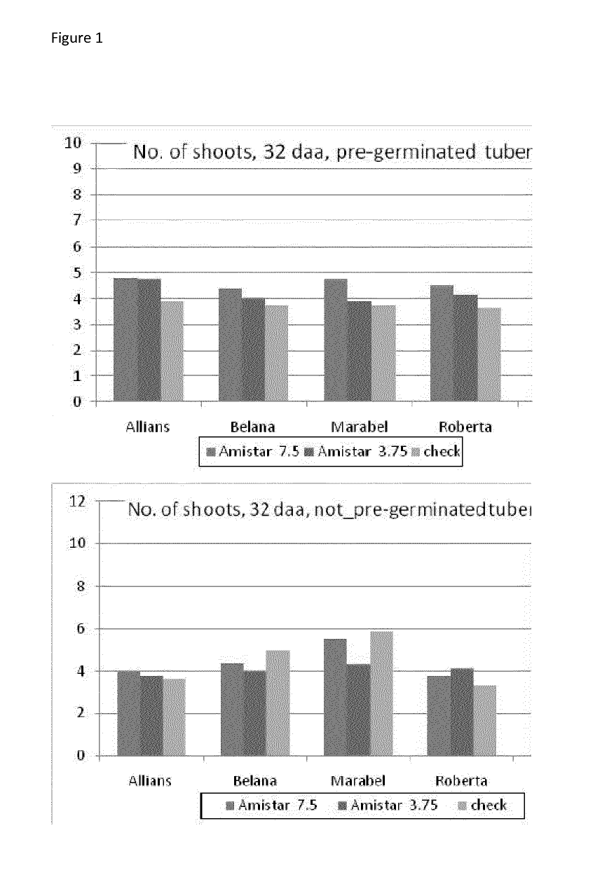

FIG. 1 shows the increased number of shoots for each trial in comparison with the check.

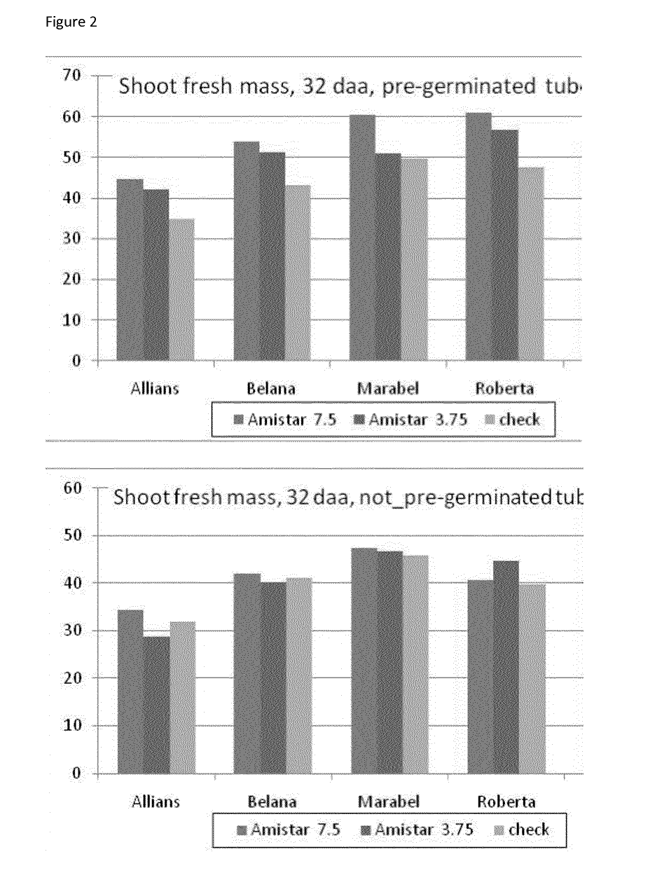

FIG. 2 shows the increased shoot fresh mass for each trial in comparison with the check.

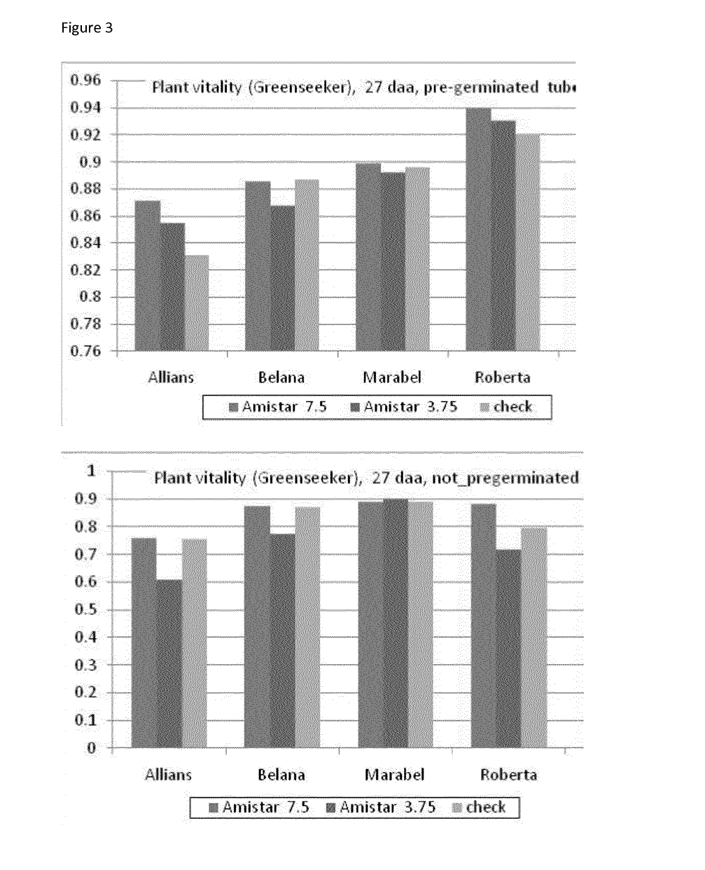

FIG. 3 shows the increased plant vitality for each trial in comparison with the check.

Plant vitality was measured with the “Green Seeker” system.

Conclusion

Low Azoxystrobin amounts sprayed on potato tubers caused positive crop enhancement effects especially on pre-germinated tubers of all varieties tested:

Shoot number was increased

Shoot fresh mass was significantly increased for all varieties after azoxystrobin spray

Plant vitality was better than check for Allians and Roberta when pre-germinated, but often showed a lower value for the low rate treatment. Effects are more pronounced when tubers are pre-germinated.

1.2 Experiment

A commercially available SC100 formulation of azoxystrobin was sprayed directly to uncovered potato tubers, which were sitting on soil (50% drench soil mixed with 50% sand), at:
3 g/ha

The spray volume was 200 l/ha.

The check had no treatment of azoxystrobin.

The trials were repeated in 6 troughs with 3 tubers each.

Varieties tested were Allians, Belana, Marabel and Roberta. Each were tested as pre-germinated (i.e. treatment was applied when the potato tuber had 2-3 mm long sprouts) tubers.

The temperature was held at about 10° C. during the day and night to simulate cold stress.

No pest pressure present.

Visual Plant Growth was Measured 21 Days after Application:

| Variety | % increased growth vs Check |
|---|---|
| Allians | 38 |
| Belana | 12 |
| Marabel | 37 |
| Roberta | 10 |

All treated tubers grew better than untreated check.

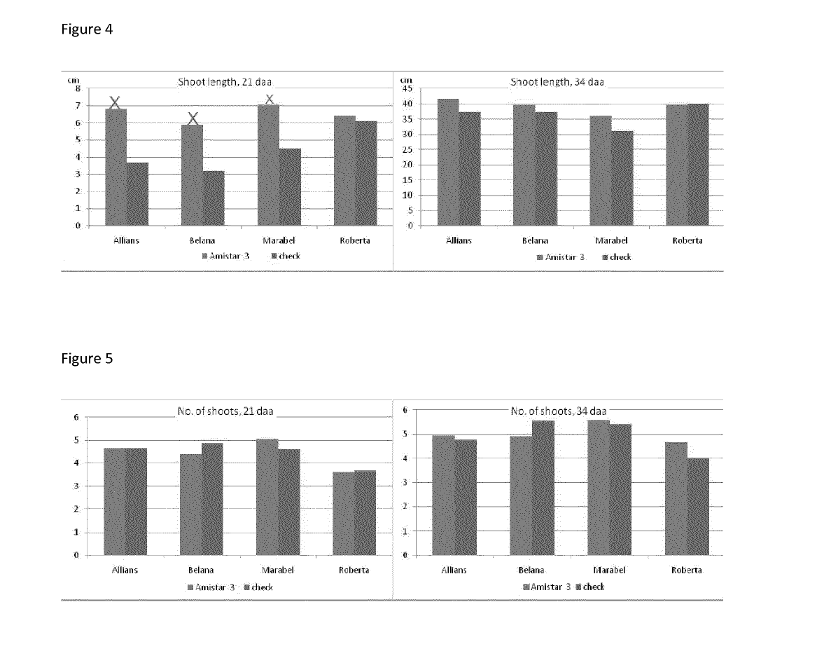

FIG. 4 shows the increased shoot length for each trial in comparison with the check 21 and 34 days after application.

FIG. 5 shows the increased number of shoots for each trial in comparison with the check 21 and 34 days after application.

Conclusion

Low Azoxystrobin amounts sprayed on potato tubers caused positive crop enhancement effects especially on pre-germinated tubers of all varieties tested, even at LOW temperatures of 10° C.:

Shoot length was increased

Number of shoots was increased

Visually up to 38% more shoot than check

These effects are particularly useful for early season potato growers, who need potato plants to withstand cold early season temperatures.

1. A method for increasing the resistance of potato plants to cold stress which comprises treating the potato tubers and/or the surrounding growing medium with at least one strobilurin at a rate of less than 25 g/ha.

2. A method for improving plant growth of potato plants which comprises treating the potato tubers and/or the surrounding growing medium with at least one strobilurin at a rate of less than 25 g/ha.

3. The method according to claim 1 wherein the strobilurin is selected from pyraclostrobin, dimoxystrobin, picoxystrobin, trifloxystrobin, enestroburin, orysastrobin, metominostrobin, azoxystrobin and fluoxastrobin.

4. The method as claimed in claim 1, wherein the strobilurin is selected from azoxystrobin.

5. The method as claimed in claim 1, wherein the strobilurin is applied at a rate of less than 15 g/ha.

6. The method as claimed in claim 1, wherein the strobilurin is applied at a rate of less than 10 g/ha.

7. The method as claimed in claim 1, wherein the strobilurin is applied at a rate of less than 7.5 g/ha.

8. The method as claimed in claim 1, wherein the strobilurin is applied at a rate of less than 5 g/ha.

9. The method as claimed in claim 1, wherein the potato tubers are pre-germinated before treating the tubers with strobilurin.

10. The method as claimed in claim 1, wherein the potato tuber treated with strobilurin results in earlier germination and/or increased emergence and/or increased plant height and/or increased root length and/or increased chlorophyll content and/or improved plant vitality and/or increased shoot number and/or increased shoot length and/or increased shoot fresh mass.

11. The method as claimed in claim 1 for increasing the plant's resistance towards cold temperatures of at most 15° C.

12. The method as claimed in claim 11 for increasing the plant's resistance towards cold temperatures of at most 10° C.

13. The method according to claim 1, wherein the tubers and/or surrounding growing medium are treated with at least one strobilurin at a rate of less than 25 g/ha at the time of planting or immediately after covering the tuber with growing medium.

14. The method according to claim 1, wherein the tubers are treated with strobilurin before being planted.

15. The method according to claim 14, wherein, on planting, the surrounding growing medium is treated with at least one strobilurin, the total amount of strobilurin being applied to the tuber and surrounding growing medium being less than 25 g/ha.

16. The method according to claim 1, wherein a fungicidally effective amount of a strobilurin is applied after treatment of the tuber and/or surrounding growing medium with at least one strobilurin at a rate of less than 25 g/ha.

17. The method of claim 1, wherein
a. the potato tubers are placed in the soil;
b. the strobilurin is applied to the uncovered potato tubers or surrounding growing medium before covering the potato tubers with growing medium.

18. The method according to claim 17 wherein the following additional steps are carried out:
c. the treated uncovered potato tubers and surrounding growing medium are covered with further growing medium;
d. and optionally additional strobilurin is applied on the cover growing medium and
wherein overall less than 25 g/ha of strobilurin is applied.

19. The method according to claim 17, wherein a fungicidally effective amount of a strobilurin is applied after treatment of the tuber and/or surrounding growing medium with at least one strobilurin at a rate of less than 25 g/ha.

20. The method of claim 1, wherein the growing medium is soil.
